(19) United States
(12) Patent Application Publication
(10) Pub. No.: US 2026/0213420 A1
(43) Pub. Date: Jul. 23, 2026

(54) OPTICAL TRAVELLING-WAVE ANTENNA WITH STOPBAND CLOSURE THROUGH ASYMMETRICAL GRATING

(71) Applicant: Dell Products L.P., Round Rock, TX (US)

(72) Inventors: Tejinder Singh, San Jose, CA (US); Navjot Kaur Khaira, San Jose, CA (US); Morris Repeta, Ottawa (CA); Keigan Macdonell, Ottawa (CA); Shulabh Gupta, Ottawa (CA)

(21) Appl. No.: 19/244,908

(22) Filed: Jun. 20, 2025

Related U.S. Application Data
(60) Provisional application No. 63/747,228, filed on Jan. 20, 2025.

(51) Int. Cl. H01Q 13/28

(52) U.S. Cl. CPC H01Q 13/28

(57) ABSTRACT

The technology described herein is generally directed towards an optical grating antenna (coupler) designed as a travelling wave or leaky wave antenna, based on laterally asymmetrical structural perturbations along the top (wire) of the antenna. In one implementation, the perturbations are protrusions in the form of nanopillar pairs distributed along the top of the antenna. The lateral asymmetry in the nanopillar segment pairs' distribution produces strong emissions in the broadside direction based on destructive interference of reflections resulting from the asymmetry, unlike conventional grating antennas with high reflections resulting in a stopband at broadside emission. The optical antenna, which can be implemented as a silicon-on-insulator waveguide, is suitable for linear-polarized emissions in the telecommunications infrared C-band, as well as in other applications including holography. Instead of laterally asymmetrical nanopillar pairs, other implementations can use structural perturbations of different geometries, including different shapes and/or notches/trenches in the antenna structure.

### RELATED APPLICATION

The subject patent application claims priority to U.S. Provisional Patent Application Ser. No. 63/747,228, filed Jan. 20, 2025, and entitled “Optical Travelling-wave Antenna with Stop-band Closure Through Asymmetrical Grating” (docket no. 141983.01/DELLP1499US), the entirety of which patent application is hereby incorporated by reference herein.

### BACKGROUND

Optical antennas are used in various applications, including in displays, sensors, high throughput wireless communications, and as laser sources. Grating couplers are a subset of optical antennas, and are composed of a waveguide with perturbations. The perturbations permit coupling between the guided mode through the structure.

### BRIEF DESCRIPTION OF THE DRAWINGS

The technology described herein is illustrated by way of example and not limited in the accompanying figures in which like reference numerals indicate similar elements and in which:

FIG. 1 is a representation of an example grating antenna model including laterally asymmetrical nanopillars, in accordance with various example embodiments and implementations of the subject disclosure.

FIG. 2 is a representation of an example grating antenna design highlighting various example dimensions, in accordance with various example embodiments and implementations of the subject disclosure.

FIG. 3 is a truncated representation of an example grating antenna including laterally asymmetrical nanopillars, and highlighting various example dimensions, in accordance with various example embodiments and implementations of the subject disclosure.

FIG. 4 is a graphical representation showing reflected magnitude at an input port of an example grating antenna, configured with asymmetrical perturbations, versus frequency for various pillar offset values, in accordance with various example embodiments and implementations of the subject disclosure.

FIG. 5 is a graphical representation showing reflection and transmission S-parameters versus frequency for a grating antenna configured with generally optimal asymmetrical nanopillar separation distances, in accordance with various example embodiments and implementations of the subject disclosure.

FIG. 6 is a graphical representation of the transmission S-parameter of an example grating antenna configured with asymmetrical perturbations, which shows an increase in broadside emission as the perturbation separation approaches the one-quarter of the optical wave's wavelength, in accordance with various example embodiments and implementations of the subject disclosure.

FIG. 7 is a graphical representation of the co-polarized and cross-polarized realized gains of an example grating antenna configured with asymmetrical perturbations, in accordance with various example embodiments and implementations of the subject disclosure.

FIG. 8 is a graphical representation of the gain pattern at a design frequency for the generally optimized grating antenna configured with asymmetrical perturbations, in accordance with various example embodiments and implementations of the subject disclosure.

FIG. 9 is a graphical representation of the realized gain of the generally optimized example grating antenna across a bandwidth of 150-230 THz, showing generally level broadside emissions, in accordance with various example embodiments and implementations of the subject disclosure.

FIG. 10 is a graphical representation of the realized antenna gain of the generally optimized example grating antenna, showing beam steering with various frequencies, in accordance with various example embodiments and implementations of the subject disclosure.

FIG. 11 is a zoomed-in representation of the graphical representation of FIG. 10 indicating no significant reduction in efficiency as the main lobe passes through the broadside (at 0°), in accordance with various example embodiments and implementations of the subject disclosure.

FIGS. 12A-12D are example representations of grating antennas designed with different asymmetrical perturbation designs and geometries, including rotated nanopillars (FIG. 12A), cylindrical nanopillars (FIG. 12B), cylindrical notches (FIG. 12C), and cuboid trenches (FIG. 12D), in accordance with various example embodiments and implementations of the subject disclosure.

### DETAILED DESCRIPTION

A grating antenna is a type of travelling wave antenna that couples a guided mode to a radiating mode via physical perturbations in the waveguiding structure. The physical perturbations are in the form of pillars or grooves such as trenches or nanopillars etched into the waveguiding structure. The direction of the emissions depends on the periodicity of the perturbations and the frequency of operation. Conventional grating antennas experience a decrease in realized gain as the operational frequency shifts towards a guided wavelength that is equal to the period of the perturbation. Indeed, in traveling wave antennas a sharp reduction in matching (high reflection of the input energy occurs) across a frequency band that produces broadside emissions; this reduction in efficiency through this frequency range is referred to as a stopband problem.

The technology described herein is generally directed towards an optical travelling wave antenna that achieves high broadside gain and overcomes the stopband problem by implementing the perturbation as a pair of features that have asymmetric geometry. In one implementation, such an asymmetrical grating antenna is based on pairs of perturbations that are pairs of nanopillars on top of the waveguide, which are separated such that the reflections from the two nanopillars destructively interfere to improve matching (e.g., a separation of about λ_{g}/4 at the frequency producing the broadside emissions).

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in optical antennas in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

As will be understood, described herein is a grating antenna that can be constructed through nanofabrication techniques, such as realized as silicon-on-insulator (SOI) devices. As one example usage, by clustering multiple grating antennas as described herein into an array with independently tuned phase, amplitude, and directivity, a reconfigurable, holographic display can be produced.

Several design variants of the grating antenna are described herein, each of which overcomes the well-known broadside, bandstop issue through an incorporation of asymmetrical perturbations. The offsets of the perturbations are optimal, due to the phase relation of the reflected waves between the perturbations experiencing destructive interference.

These variants tailor their emissions based on directivity and polarity, and demonstrate the ability to maximize broadside gain in an optical grating antenna. The design variants have been successfully demonstrated in simulations, and have dimensions that can be fabricated through e-beam lithography.

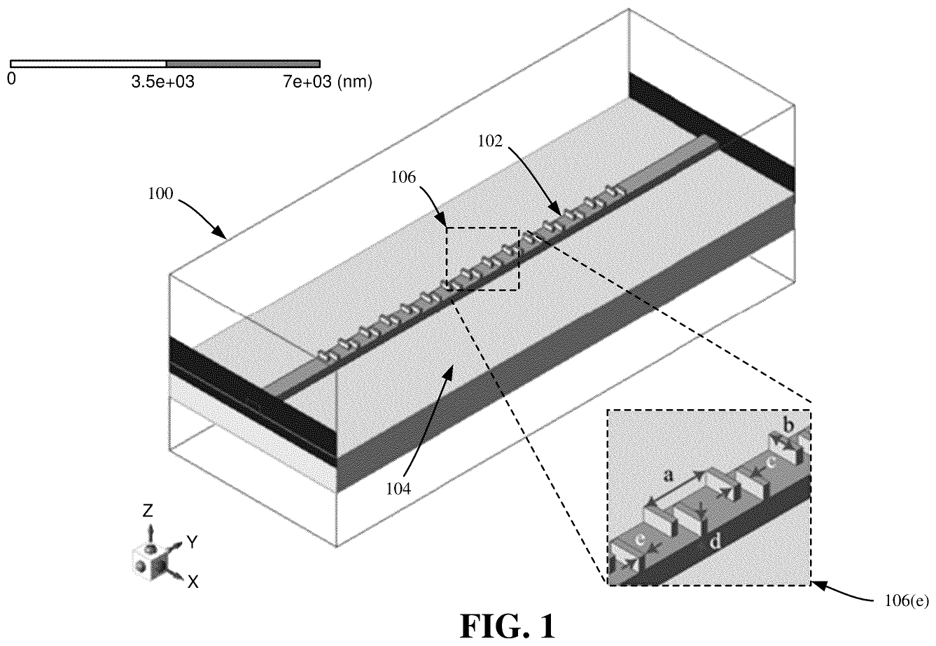

FIG. 1 is a three-dimensional (3D) representation of a model of a grating antenna structure 100 including a (e.g., silicon) wire 102 on a (e.g., silicon dioxide) substrate 104. A portion 106 of the of the structure 100 is shown enlarged relative to the model; this zoomed-in portion 106(e) includes labels a-e for various design dimensions.

In one implementation of the example model of FIG. 1, the structure 100 includes a 450 nm (nanometer) by 220 nm silicon wire 102 on silicon dioxide 104, designed as a passive grating antenna waveguide. The dimensions of the laterally asymmetrical nanopillars in this example are a=670 nm, b=300 nm, c=170 nm, d=140 nm, and e=70 nm. The dimensioned model for the example optical grating antenna of FIG. 1 results in an

optical antenna that uses a silicon wire for the waveguide, with the perturbations designed as rectangular (cuboid) nanopillars on top. As can be seen, the perturbations are periodically arranged, such that they are separated by a distance equal to the guided wavelength, and the pairs of nanopillars have lateral and longitudinal asymmetry. The nanopillars occur in pairs that are offset laterally to provide asymmetry, and are separated by λ_{g}/4 in order to cancel reflections and improve matching. The pairs are separated by λ_{g} for a free space operational wavelength of 1.55 μm (194 THz), in order to produce broadside emissions (θ=0°).

The length of the antenna can be reduced (e.g., to improve simulation time in simulated models), or can be elongated to improve the realized gain in applications. In other words, in practice, the actual length of the antenna is increased towards the millimeter scale to leak nearly all of the input power to the free-space emission and to mitigate beam divergence in the far-field, with the reduced-size model shown herein designed and simulated for convenience. For simulations, the length of the grating antenna element is restricted to 1500 nm for 15 perturbations, which was a reduced-size model. Notwithstanding, although to increase the power coupled to free space the grating antenna length is increased towards the millimeter scale, it is noted that the perturbations can be engineered to increase coupling across a shorter length to realize a smaller-aperture device.

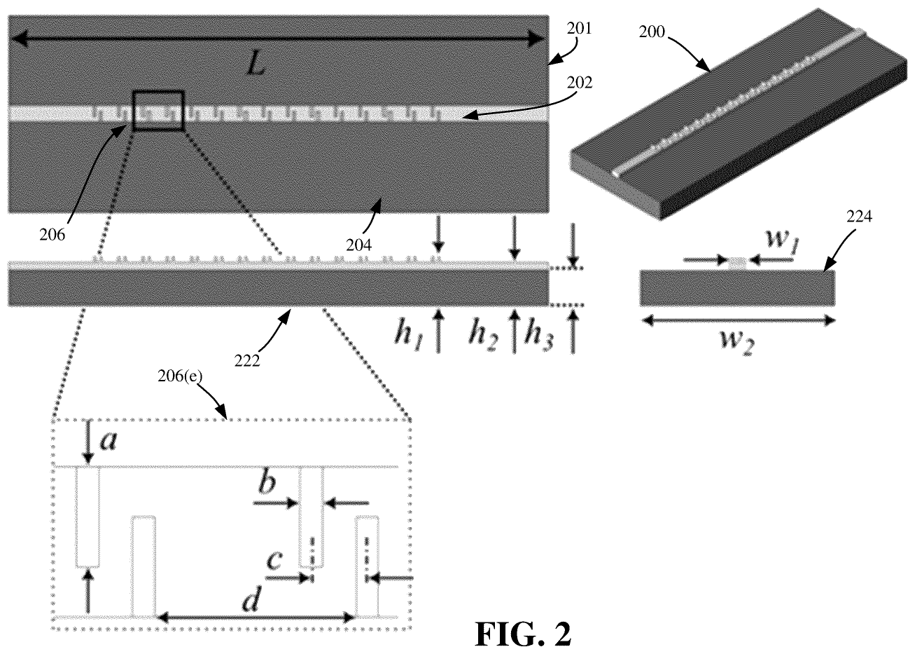

FIG. 2 shows an example structure 200 similar to that of FIG. 1, along with two-dimensional (2D) views of the model, with labels corresponding to those of FIG. 1 with similar components labeled 2xx instead of 1xx. A top view 201 is included in FIG. 1, along with a side view 222 showing height dimensions for the substrate, wire and pillars h₁, for the substrate and wire h₂, and for the substrate h₃. Width dimensions for the pillar w₁ and for the substrate w₂ are shown in the side view 224. In general, the leaked power per unit length can be tailored by decreasing the size of the perturbations.

In the example of FIG. 2, the grating antenna model with the silicon wire waveguide 202 constructed on silicon dioxide 204 is sized to support a single guided fundamental transverse electric mode. Example dimensions in FIG. 2 are L=15 μm, h₁=360 nm, h₂=220 nm, h₃=1 μm, w₁=450 nm, w₂=5450 nm, a=300 nm, b=67 nm, c=168 nm, d=603 nm. Changing (e.g., increasing) the pillar displacements, corresponding to dimension c in FIG. 1, results in improved matching as the asymmetrical nanopillars approach λ_{g}/4 offset.

The grating antenna concept in FIG. 2 thus results in a silicon waveguide optimized to carry a single transverse electric mode at the design frequency (e.g., around 194 terahertz (THz)/a free-space wavelength of λₒ=1.55 μm). The nanopillars, deposited on top, are the physical perturbations that couple the guided mode to a free-space emission. The perturbations are periodically arranged, such that they are separated by a distance equal to the guided wavelength. The pairs of nanopillars have asymmetry, which results in good efficiency for broad-side emissions.

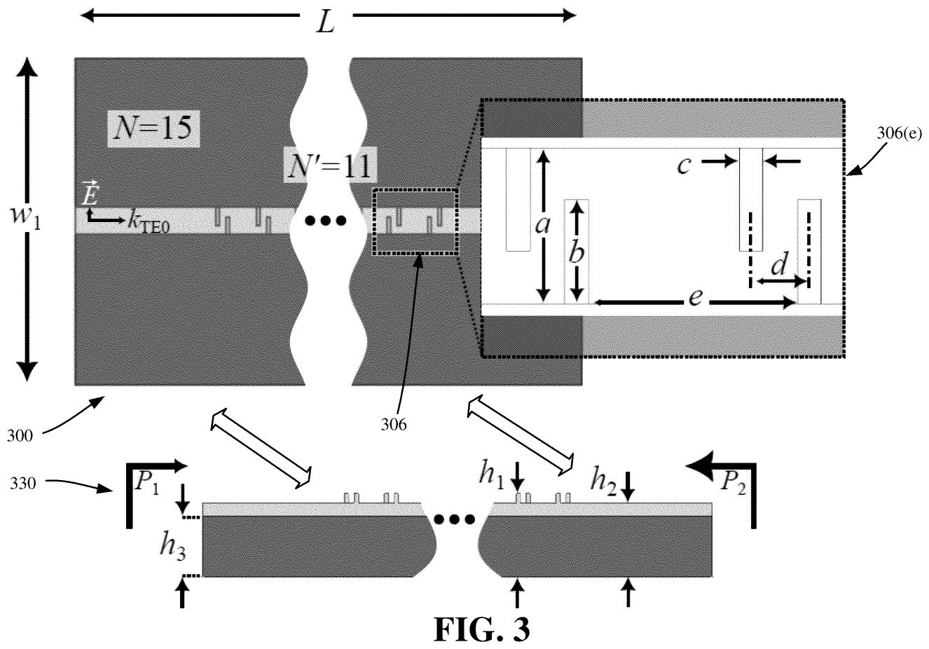

In another example model, FIG. 3 shows a truncated diagram of a grating antenna structure 300, showing alternative antenna dimensions. The transverse electric dominant mode TE0 expected for efficient radiation is indicated by \vec{E} and k_{TE0}. The enlarged inset 306(e) in FIG. 3 more clearly shows pairs of asymmetrical perturbations in the form of nanopillars (a=450 nm, b=300 nm, c=67 nm, d=168 nm, e=603 nm, h₁=360 nm, h₂=220 nm, h₃=1 μm, w₁=450 nm, w₂=5450 nm). The lower portion of FIG. 3 is a dimensioned profile view 330 of the grating antenna structure 300, showing the simulated excitation ports (P₁∧P₂).

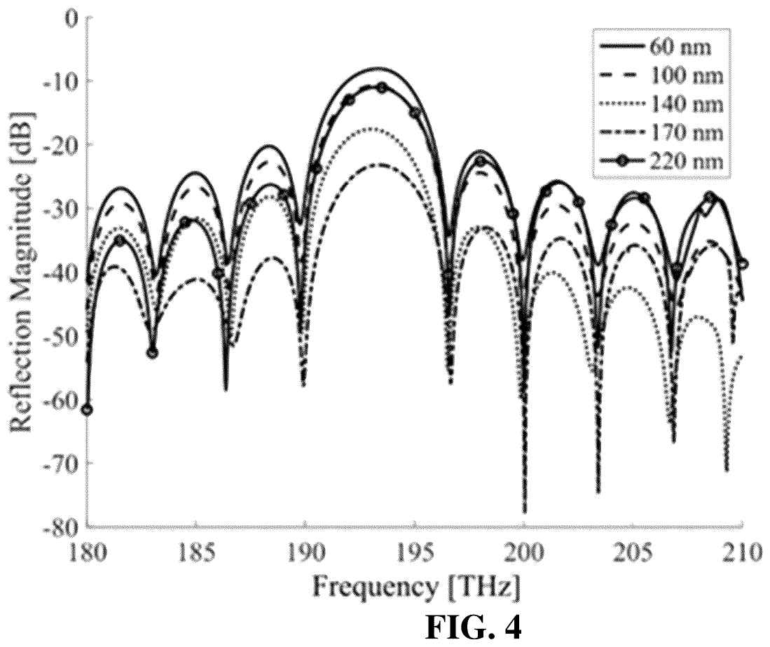

FIG. 4 shows the reflected magnitude at the input port of the grating antenna versus frequency for a number of nanopillar offset (dimension d values) configurations, showing how the S₁₁ is minimized (matching is optimized) for the λ_{g}/4 pillar separation at the frequency producing broadside emissions; a lower reflection magnitude implies better matching and greater efficiency. Indeed, the S₁₁ parameter across this dimension sweep shows that −2 dB of power is coupled to broadside emissions at the design frequency of around 194 THz (more precisely, the pillar separation distance of λ_{g}/4 minimizes the reflection magnitude at the design frequency of 193.55 THz, which is the operating frequency that produces broad-side emissions from the antenna). In part the bandstop problem is illustrated in FIG. 4, which shows how the reflected power changes with frequency (horizontal axis) and in response to a change in the nanopillar offset (dimension c from FIGS. 1-3) . More particularly, FIG. 4 shows that the reflected power is minimized as the perturbation separation approaches λ_{g}/4, which is approximately a nanopillar offset of 170 nm. This optimal configuration is due to the reflections from each nanopillar in a pair having a phase offset of ninety degrees, which implies destructive interference. The asymmetry in each pair and their offset are the factors that improve matching of the antenna.

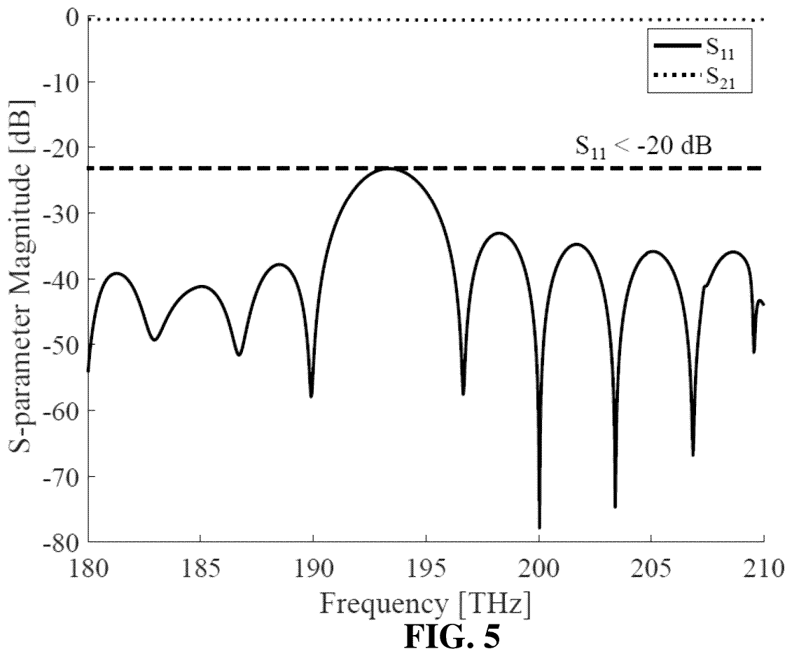

The reflection S₁₁ and transmission S₂₁ S-parameter magnitudes versus frequency are plotted in FIG. 5 for the optimal pillar geometry separation condition, e.g., a separation of d=168 nm, for which matching is less than −20 dB across the frequency sweep. The transmission coefficient (S₂₁) shows near unity transmission, and as such, for a sufficiently long antenna, the total input power expected to be radiated from the antenna is thus near unity.

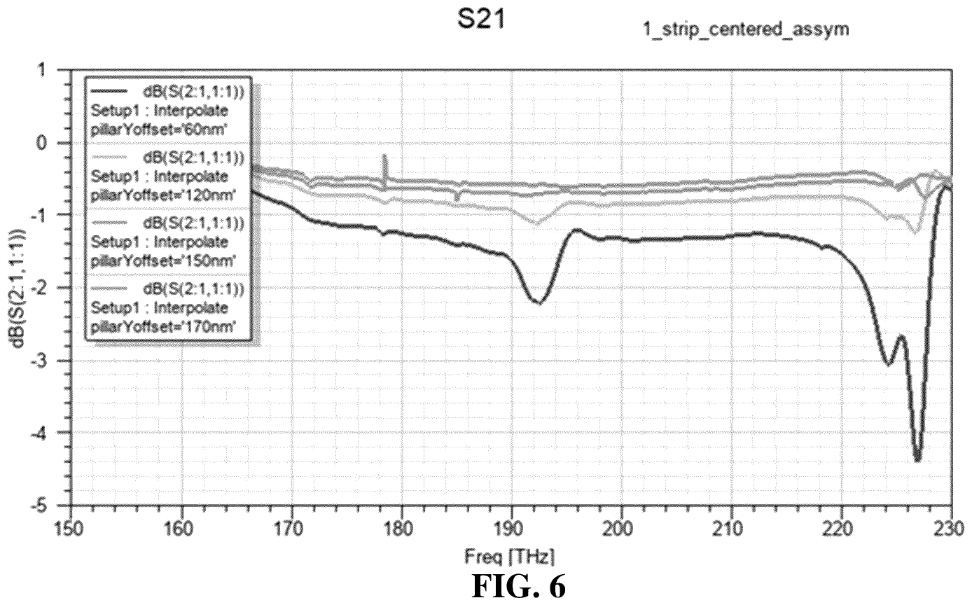

FIG. 6 is a plot of the S₂₁ parameter of the example antenna versus frequency for various pilar offsets, which shows a dip representing an increase in broadside emission as the perturbation separation approaches λ_{g}/4.

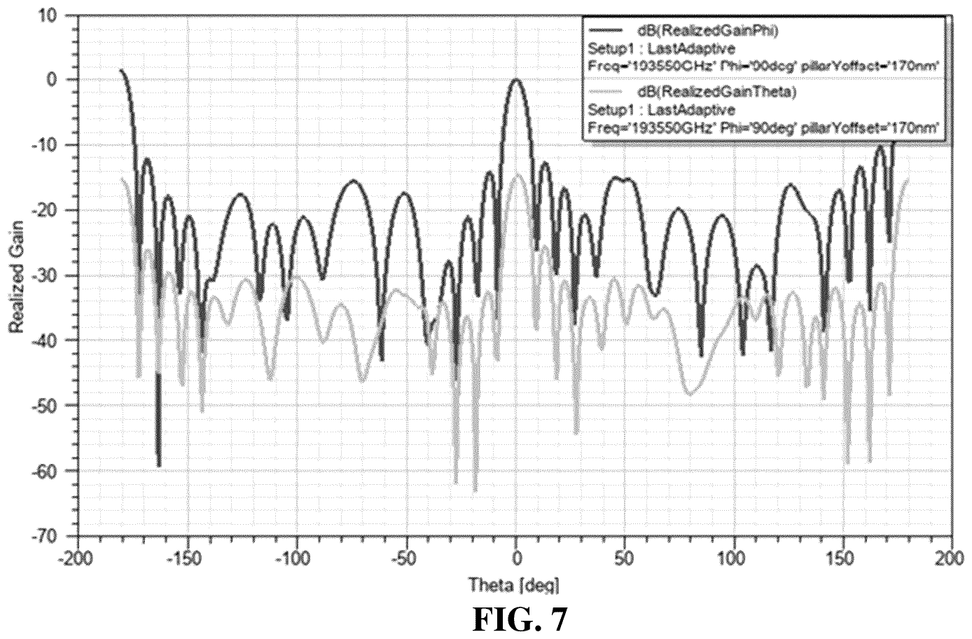

FIG. 7 shows realized gain in dB versus polar angle (theta, in degrees) for the co-polarized (dark plot) and cross-polarized realized gains (lighter gray plot) of the grating antenna. More particularly, FIG. 7 shows the radiation pattern about the y-axis (i.e. orthogonal to the longitudinal axis of the antenna) for two polarities. The co-polarized gain is shown to be approximately 15 dB greater than the cross-polarized gain, indicating good linearity.

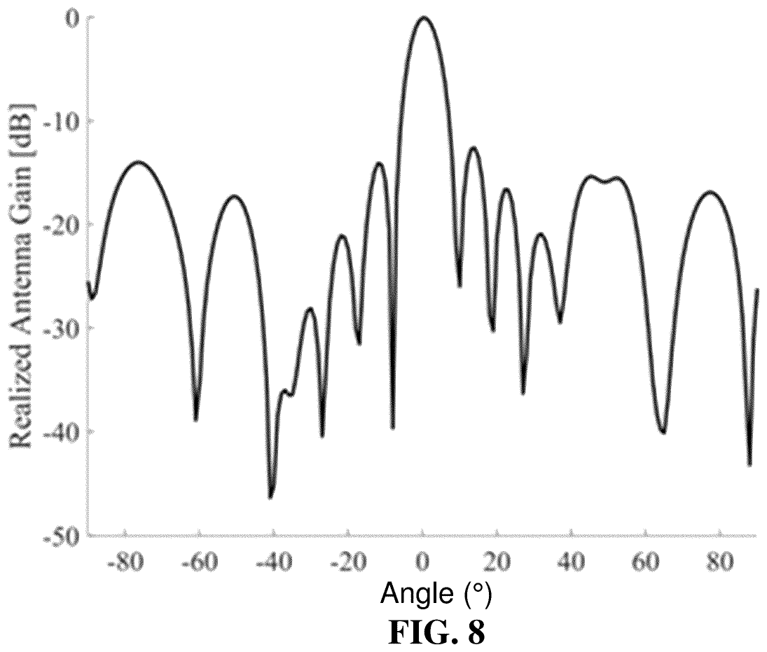

FIG. 8 plots the gain pattern for the example optimized grating antenna at 193.55 THz, showing broadside emission by the optimized antenna. As the antenna length is increased, more leakage of power across a large area will result in highly directive broadside beam.

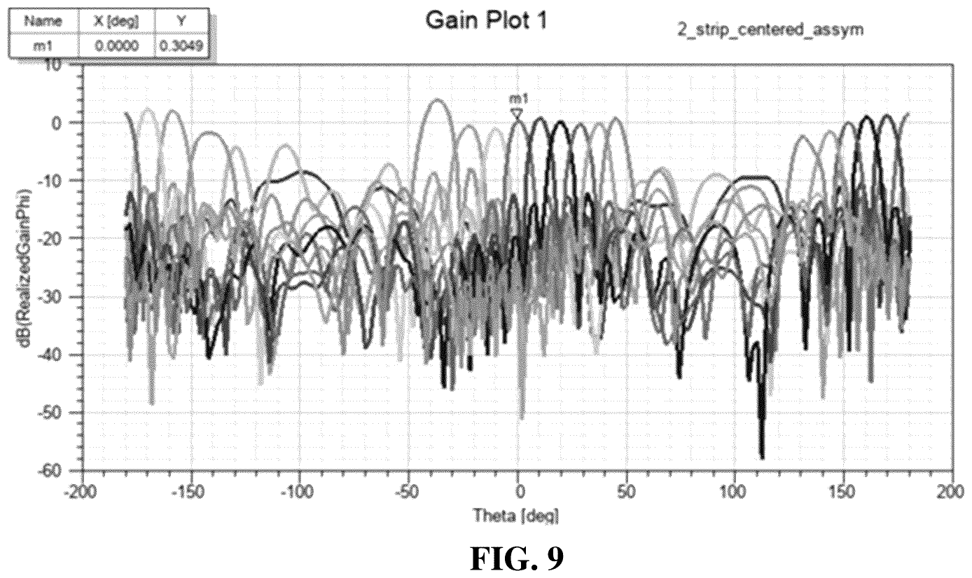

FIG. 9 is a plot of realized gain across a bandwidth of 150-230 THz, showing level emissions through the broadside representative of co-polarized gains across a frequency sweep. It can be observed from FIG. 9 that the gain is maintained across beam-steering angles of ±40°, which indicates that the stopband issue is substantially resolved by the technology described herein.

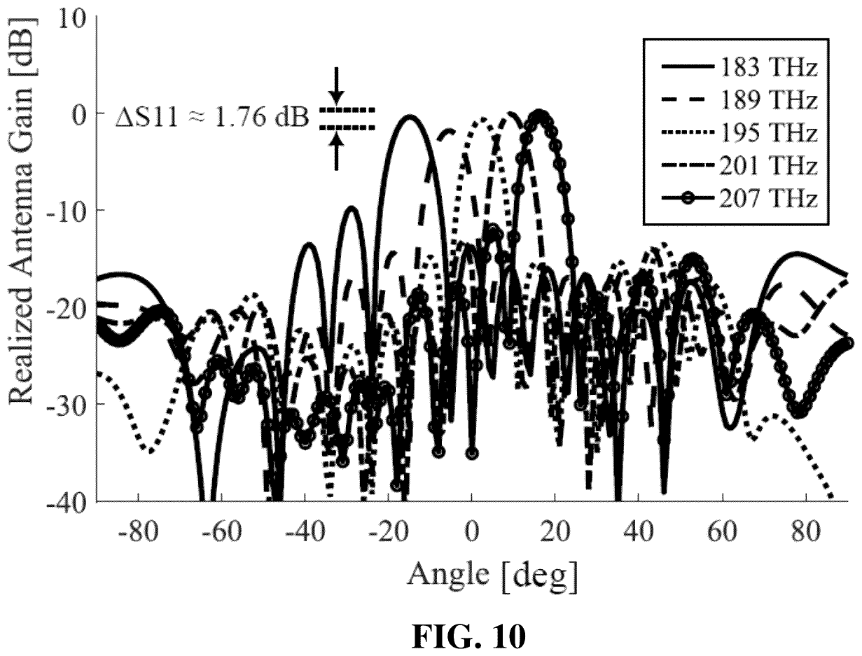

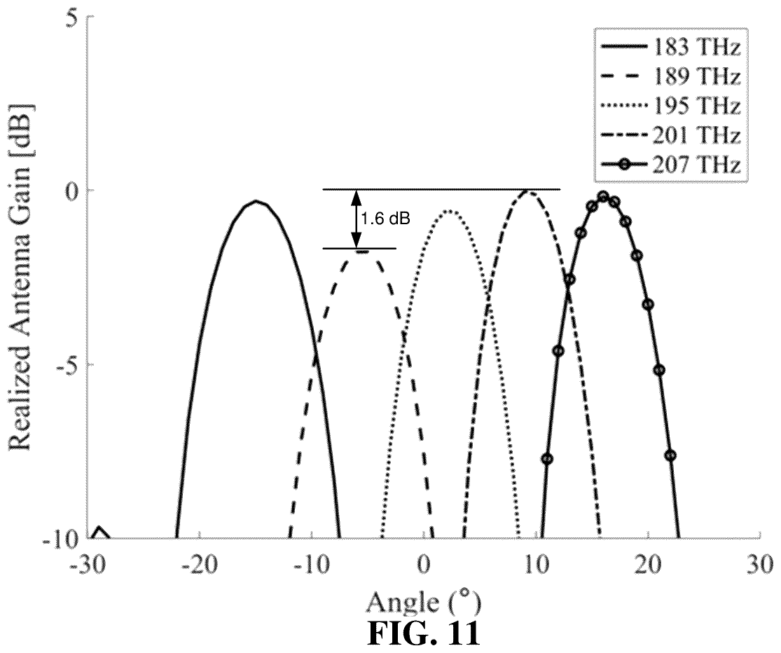

FIG. 10 is a gain plot showing beam-steering across about forty degrees with variation in frequency. As highlighted in FIG. 11 (a zoomed-in section of FIG. 10), the example designs described herein show no significant reduction in efficiency as the main lobe passes through the broadside (0°), which is a result of the engineered pillar offset and asymmetry.

Indeed, the gain patterns of the optical antenna across a sweep of frequency shown in FIGS. 10 and 11 show the output gain having only minor variation (approximately 1.76 dB, or ±10 percent) across the sweep, indicating that the stopband has been successfully suppressed. As the antenna length is increased, more leakage of power across a large area results in highly directive broadside beam that is almost uniform and reconfigurable with the excitation frequency. These patterns are un-normalized, in contrast to many examples in the literature that typically normalize the patterns to emphasize uniform beamforming (e.g. sidelobe level reduction) across wavelength-scanning sweep. As shown in FIG. 10, for the optimal λ_{g}/4 pillar separation condition, the un-normalized radiation patterns of the H-plane cut are plotted across a wide frequency sweep (183-207 THz), which produces a near unison single beam-scanning across approximately ±20°.

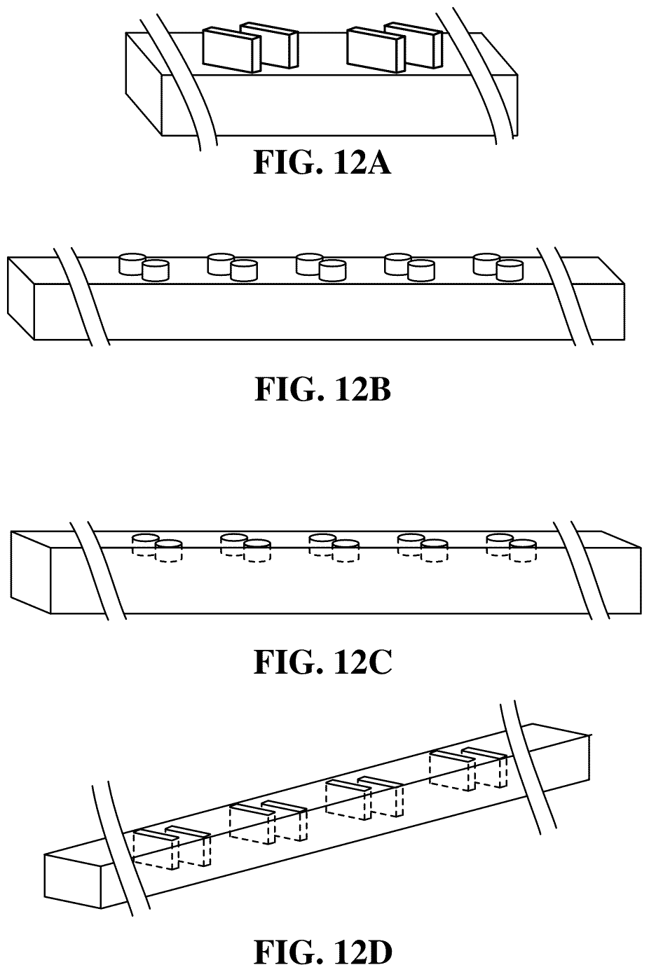

While the examples of FIGS. 1-3 and the associated example plots of FIGS. 4-11 have been described based on lateral asymmetry in cuboid nanopillar perturbations to enhance matching for broadside emissions, the technology described herein is not limited to these example designs. Indeed, it is noted that this asymmetrical grating antenna technology can be extended to any kinds of structural perturbations, including plasmonic resonant elements and notches as opposed to the nanopillar perturbations described herein. Further, as one design alternative, it is noted that rotation of the perturbations produces rotation of the radiated mode's polarity, as generally represented in FIG. 12A.

The technology described herein is thus valid for arbitrary perturbation geometries. For example, asymmetrically arranged perturbations in the form of cylindrical protrusions (FIG. 12B), cylindrical notches (cavities/depressions, FIG. 12C), or rectangular (cuboid) notches (FIG. 12D, also referred to as trenches) will provide similar results. These are only some nonlimiting examples, and other asymmetrically offset shapes can be used as protrusions or cavities. Any combination of such designs can be used, e.g., rotated notches (cavities instead of protrusions as in FIG. 12A) can be used as well.

Furthermore, the approach towards designing asymmetrical perturbations can be extended towards traveling wave variants which (for example) realize circularly polarized emissions or leverage plasmonic structures to exert better control over beamforming and antenna efficiency.

To summarize, described herein is a grating antenna with a (e.g., silicon) wire atop a substrate, and asymmetrical perturbations along a portion of the length of the wire to facilitate operation as a waveguide. The grating antenna achieves high broadside gain based on the lateral asymmetry in the perturbations, which results from splitting the perturbations (e.g., nanopillars) into offset segments. The offset segments are separated by a longitudinal distance of approximately λ_{g}/4 in order to cancel reflections and improve matching. In one implementation, the antenna functions at a wavelength of 1.55 μm, which is found in conventional telecommunications bands. The grating antenna described herein overcomes the stopband problem experienced by conventional grating antennas, as uniform gain is maintained via the grating antenna described herein across a given frequency range with generally maximal emission at a normal angle to the substrate; the direction of the emissions depends on the periodicity of the perturbations and the frequency of operation.

Thus, the lateral asymmetry in the perturbations enhance matching for broadside emissions. Rotation of the perturbations can be used to produce rotation of the radiated mode's polarity. Further, the asymmetrical perturbations-based technology described herein is valid for arbitrary perturbation geometries, including for trenches or nanopillars, but also including geometries such as asymmetrically arranged cylindrical, or rectangular notches.

As can be seen, described herein in one nonlimiting implementation is a silicon-on-insulator (SOI) waveguide with protrusions in the form of nanopillars distributed along the top, which serve as perturbations to couple the guided mode to a directed free-space emission. The technology described herein leverages lateral asymmetry in the nanopillar distribution to produce strong emissions in the broadside direction; this is in contrast to conventional grating antennas, which suffer high reflections through frequencies (e.g., a stopband) that produce broadside emission. The technology is suitable for an optical antenna for linear-polarized emissions in a telecommunications infrared (IR) band (e.g., 1550 nm or 194 THz)/the infrared C-band (e.g., 191.6-195.9 THz). In one implementation, the optical antenna design is a travelling wave or leaky wave antenna, which operates as a grating coupler/dielectric waveguide to couple the guided mode through the grating structure to some other mode, which can be either the guided mode of another waveguide structure (e.g. a fiber-optic cable which is abutted to the wafer), or a propagating free space mode, in which case the structure is operated as a travelling wave antenna. The direction of propagation is dependent on the input wavelength. The technology described herein thus overcomes the stop-band problem by establishing structural asymmetry at the unit cell level (e.g., both transverse and longitudinal to the scanning plane of the grating antenna), thereby achieving uniformly high efficiency across the frequency span.

Optical antennas are applicable to displays, sensors, high throughput wireless communications, and as laser sources, including in an alternative guiding mode (e.g. a fiberoptic cable mode). These structures are particularly useful as couplers between traveling wave modes as in a photonic integrated circuit (PIC) and free space or guided fiber-optic modes. Usage examples of the technology described herein include, but are not limited to, a LIDAR source; the grating coupler can be implemented as a high-directivity laser source for LIDAR applications, for which a device containing an array of these antennas can be used to detect and range-find along directions paraxial to the wafer normal vector. Such a device, which can be part of a chip-scale optical phased array, benefits from high efficiency across a large frequency range and beam-steering angles.

Another usage example is with respect to sensors and monitoring, as chemicals and substances have characteristic absorption spectra through the infrared frequency range, and therefore can be detected and monitored through detection of transmitted light from a source. For this purpose, the design described herein can be applied as a source, because the output power is universally high across the operating frequency range with the advent of band-stop suppression.

Infrared wireless communications are facilitated, as optical wireless links benefit from high throughput, low latency, and high capacity. A device based on this antenna design described herein can be used to establish wireless links that are dynamic, being steered in real time to address different targets in an environment. Furthermore, these antennas can be used in conjunction with RF-domain antennas, given their size and integrability.

The general strategy of maximizing efficiency for broadside emissions can be integrated into more conventional grating couplers, which are widespread for prototyping of photonic circuits in research and industry.

Further, the technology can be used as part of an optical radiator applied for holographic displays, which encode both magnitude and phase information on a per-pixel basis in order to create the illusion of depth to a spectator.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple chips or multiple devices can share the performance of one or more functions described herein, and similarly, the designs can be effected across a plurality of devices. Accordingly, the various embodiments are not to be limited to any single implementation, but rather are to be construed in breadth, spirit and scope in accordance with the appended claims.

What is claimed is:

1. A device, comprising:
a substrate; and
a grating antenna comprising a waveguide above the substrate, the grating antenna comprising a wire having perturbations distributed along a portion of the wire, wherein the perturbations are configured as respective asymmetrical groups of the perturbations configured to produce destructive interference of respective reflections from the respective asymmetrical groups of the perturbations.

2. The device of claim 1, wherein the respective asymmetrical groups of the perturbations comprise respective pairs of laterally offset nanopillars.

3. The device of claim 2, wherein the perturbations comprise cuboid-shaped nanopillars.

4. The device of claim 2, wherein the perturbations comprise cylindrical-shaped nanopillars.

5. The device of claim 1, wherein the respective asymmetrical groups of the perturbations comprise respective pairs of laterally offset notches.

6. The device of claim 2, wherein the perturbations comprise cuboid-shaped trenches.

7. The device of claim 2, wherein the perturbations comprise cylindrical-shaped notches.

8. The device of claim 1, wherein the respective asymmetrical groups of the perturbations are periodically distributed based on a wavelength of an input optical wave.

9. The device of claim 1, wherein the respective asymmetrical groups of the perturbations have respective lateral offsets based on a wavelength of an input optical wave.

10. The device of claim 1, wherein the respective asymmetrical groups of the perturbations comprise parallel pairs of perturbations that are perpendicular relative to a length of the wire.

11. The device of claim 1, wherein the respective asymmetrical groups of the perturbations comprise parallel pairs of perturbations that are rotated relative to a length of the wire.

12. The device of claim 1, wherein the grating antenna is configured to operate at an optical frequency band.

13. The device of claim 1, wherein the substrate comprises silicon dioxide, and wherein the wire comprises silicon.

14. An optical travelling-wave antenna, comprising:
a substrate;
a wire along a length of the substrate; and
respective pairs of perturbations periodically distributed along the wire, the respective pairs of the perturbations comprising respective first perturbations and respective second perturbations, wherein the respective second perturbations are laterally offset asymmetrically relative to the respective second perturbations first perturbations, and wherein respective offset distances between the respective first perturbations and the respective second perturbations are based on a wavelength of an input optical wave.

15. The optical travelling-wave antenna of claim 14, wherein the respective pairs of the perturbations comprise respective pairs of nanopillars protruding above the wire and perpendicular to a length of the wire.

16. The optical travelling-wave antenna of claim 14, wherein the respective pairs of the perturbations comprise respective pairs of nanopillars protruding above the wire and rotated to respective non-perpendicular angles relative to a length of the wire.

17. The optical travelling-wave antenna of claim 14, wherein the respective pairs of the perturbations comprise respective pairs of notches in the wire.

18. A grating antenna, comprising:
a wire comprising a length dimension and a width dimension that is smaller than the length dimension; and
respective pairs of nanopillars protruding above a portion of the wire, the respective pairs periodically distributed along the portion of the wire in the length dimension, wherein the respective pairs of nanopillars comprise respective first nanopillars and respective second nanopillars, and wherein the respective first nanopillars are misaligned with the respective second nanopillars along the length dimension to create destructive interference of respective reflections resulting from an optical wave input to the grating antenna.

19. The grating antenna of claim 18, wherein the respective first nanopillars comprise respective first cuboids, and wherein the respective second nanopillars comprise respective second cuboids that are misaligned with the respective first cuboids by a lateral offset amount.

20. The grating antenna of claim 18, wherein the respective pairs of nanopillars comprise respective offset distances, between the respective first nanopillars and the respective second nanopillars, based on a wavelength of an input optical wave.
